(19) United States
(12) Patent Application Publication
(10) Pub. No.: US 2010/0233070 A1
(43) Pub. Date: Sep. 16, 2010

(54) CARBON-SUPPORTED CoSe2 NANOPARTICLES FOR OXYGEN REDUCTION AND HYDROGEN EVOLUTION IN ACIDIC ENVIRONMENTS

(76) Inventors: Nicolas Alonso-Vante, Buxerolles (FR); Yongjun Feng, Poitiers (FR); Ting He, Dublin, OH (US)

Correspondence Address: Capitol City TechLaw, PLLC, 113 S. Columbus St., Suite 302, Alexandria, VA, 22314, US

(21) Appl. No.: 12/708,162

(22) Filed: Feb. 18, 2010

Related U.S. Application Data
(60) Provisional application No. 61/153,855, filed on Feb. 19, 2009.

(51) Int. Cl. C01B 13/00; B01J 21/18; C01B 3/00; B01J 23/75; B01J 27/057

(52) U.S. Cl. 423/579; 502/185; 423/648.1

(57) ABSTRACT

The present teachings are directed to preparation of carbon-supported CoSe₂ nanoparticles via an in situ surfactant free method, and use of the same for oxygen reduction and hydrogen evolution reactions. The CoSe₂ nanoparticles have two kinds of structure after heat treatment at different temperatures: orthorhombic at 300° C. and cubic at 400° C. The latter structure has higher oxygen reduction activity and hydrogen evolution activity than the former in 0.5 M H₂SO₄. Electron transfers of about 3.5- and about 3.7-electrons were observed for 20 wt. % CoSe₂/C nanoparticles, after heat treatment at 300° C. and 400° C., per oxygen molecule during the oxygen reduction process, respectively.

### RELATED APPLICATIONS

The present application claims benefit from earlier filed U.S. Provisional Application No. 61/153,855 filed on Feb. 19, 2009, which is incorporated by reference herein in its entirety for all purposes.

### BACKGROUND

1. Field of the Invention

The present teachings relate to the preparation of carbon-supported CoSe₂ nanoparticles via an in situ surfactant free method. These CoSe₂ nanoparticles are particularly active for oxygen reduction and hydrogen evolution reactions.

2. Discussion of the Related Art

Fuel cells, as one of many new emerging technologies, can significantly improve the efficiency of energy conversion, reduce harmful emissions and dependence on oil as an energy source. This technology has wide applications in transportation, stationary and portable power supplies. Generally, Pt-based materials have been the best and most frequently used catalysts for the oxygen reduction reaction (hereinafter “ORR”) in acid media. However, Pt metal is one of the most expensive and rarest metals on the Earth's upper continental crust. This high cost of Pt-based electrocatalysts has been cited as one of the main commercialization barriers of fuel cells. Many scientists have made great efforts to reduce the Pt loading on carbon substrate and in metal alloys, or to seek other precious metals, for example, Ru, Pd and non-precious metals, such as Co- and Fe-based catalysts to completely replace Pt-based catalysts.

Transition-metal chalcogenides as potential cathodic catalysts for fuel cells, have been paid more attention, since Alonso-Vante et al., for the first time in 1986, reported the significant catalytic activity of Chevrel-phase Mo₆Se₈ (e.g., Mo₄Ru₂Se₈) towards ORR in acidic medium. However, Ru metal is also a relatively expensive and rare metal, like Pt metal.

Among the limited non-precious metals possibilities for fuel cell cathodic catalysts for ORR are Co and Fe. Prior reports on these transition metal materials were done by Baresel et al., and by Behret et al. in the 1970's. The cathodic oxygen reduction on chalcogenides of various transition metals has been further reported. For example, Co₃S₄ spinels synthesized in the range between 300° C. and 650° C. show an open circuit potential (hereinafter “OCP”) of about 0.8 V vs. a hydrogen electrode in 1 M H₂SO₄ electrolyte.

We report herein the preparation of cubic phase CoSe₂ nanoparticles supported on carbon black and their catalytic activities towards both the molecular oxygen electroreduction reaction and hydrogen evolution reaction (hereinafter “HER”) in acidic environments.

### SUMMARY OF THE PRESENT DISCLOSURE

The present teachings are directed to a method of preparing carbon-supported CoSe₂ nanoparticles by providing a support material, a Co precursor, and a Se precursor. The support material and the Co precursor are contacted together in a non-aqueous surfactant free reaction mixture, and then the reaction mixture can be heated to a maximum temperature of no greater than about 200° C. The reaction mixture is cooled, contacted with the Se precursor, heated to a maximum temperature of no greater than about 200° C., and then the supported CoSe₂-containing product is isolated.

The present teachings also include a method of reducing oxygen by providing oxygen and a Co and Se-containing electrocatalyst component. The oxygen is contacted with the Co and Se-containing electrocatalyst component, and from 3 to 4 electrons per oxygen molecule are transferred from the electrocatalyst to the oxygen to thereby reduce the oxygen. The Co and Se-containing electrocatalyst component can also be utilized to produce hydrogen via a hydrogen evolution reaction (hereinafter “HER”).

Also taught by the present disclosure is a method of converting the structure of a cobalt and selenium-containing compound by first providing a cobalt and selenium-containing compound, and then heating the cobalt and selenium-containing compound to about 300° C. to form a cobalt and selenium-containing compound with an orthorhombic structure. This orthorhombic form can be isolated, and then heated to about 400° C. to thereby form the cobalt and selenium-containing compound with a cubic structure.

This disclosure also includes an electrocatalyst for the molecular oxygen reduction or hydrogen evolution reactions which contains a carbon-supported CoSe₂ nanoparticle electrocatalyst, with the carbon-supported CoSe₂ nanoparticles being CoSe₂ nanoparticles in either an orthorhombic or cubic phase structure. The cubic structure appears to provide the most significant increase in performance over known Pt-containing electrocatalyst formulations.

In the present disclosure, it is reported that 20 wt. % CoSe₂/C nanoparticles have been successfully synthesized via an in situ surfactant free synthesis method under mild conditions with heating to less than about 200° C. CoSe₂ nanoparticles having the orthorhombic structure after heat treatment at 300° C. can then be converted to cubic structure after heat treatment at 400° C. under a nitrogen atmosphere. The cubic CoSe₂/C nanoparticles displayed higher ORR and HER activity than the orthorhombic form in 0.5 M H₂SO₄. Carbon-supported CoSe₂ nanoparticles after heat treatment from 300° C. to 400° C., as non-precious metal electrocatalysts, have a increased electrocatalytic activity for the ORR in 0.5 M H₂SO₄ with the maximum OCP of about 0.81 V vs. RHE. Electron transfers of about 3.5- and 3.7-electron were determined for CoSe₂-300 C and CoSe₂-400 C during ORR per oxygen molecule, respectively.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIGS. 1-3 are powder X-ray diffraction patterns;

FIGS. 4 and 5 are Koutecky-Levich plots at various voltages with oxygen reduction reaction curves located in the upper left corner of each plot;

FIG. 6 is a graph of the electrocatalytic activities of three differently heat treated CoSe₂ electrocatalysts, and

FIGS. 7-9 are plots of the hydrogen evolution performances of three differently treated CoSe₂ electrocatalysts.

### DETAILED DESCRIPTION

The present teachings describe a method of preparing carbon-supported CoSe₂ nanoparticles by first providing a support material, a Co precursor and a Se precursor. The first two components are contacted in a non-aqueous surfactant free reaction mixture, and heated to a maximum temperature of no greater than about 200° C. The reaction mixture can then be cooled to room temperature, and the Se precursor can be added to the reaction mixture. The reaction mixture is again heated to a maximum temperature of no greater than about 200° C., and a supported CoSe₂-containing component can be isolated from the cooled reaction mixture.

This isolated supported CoSe₂-containing component can then undergo further heating to about 300° C. to produce a supported orthorhombic phase CoSe₂-containing component, or it can be heated to about 400° C. to produce a supported cubic phase CoSe₂-containing component. These heating steps can be sequential with isolation of the orthorhombic form prior to heating to about 400° C. to form the cubic form, or in some cases, the supported CoSe₂-containing component can be heated directly to about 400° C. to form the cubic form.

During the formation of the supported CoSe₂-containing component, the time that each heating step is held at a maximum temperature of no greater than about 200° C. is the time at temperature needed to drive the reaction to substantial completion. The time and temperature for these heating steps can vary independently of one another, and can include heating for less than about 1 hour, or in some instances, can include heating for less than about 30 minutes. In some embodiments, each heating step can include heating to a maximum temperature of no greater than about 150° C. For example, and not intended to be limiting, when p-xylene is utilized as the solvent, the temperature can be held to less than about 138° C., the boiling point of pure p-xylene.

The presently disclosed method is directed to the formation of a supported CoSe₂-containing component and one suitable support material can be carbon. In some instances, the support material can include aluminas and zeolites.

Also provided by the present teachings is a method of reducing oxygen by providing oxygen, and a Co and Se-containing electrocatalyst component. The oxygen can be contacted with the Co and Se-containing electrocatalyst component, and from 3 to 4 electrons per oxygen molecule can be transferred from the electrocatalyst to the oxygen to thereby reduce the oxygen.

In some embodiments of the present method, the Co and Se-containing electrocatalyst component can include CoSe₂ nanoparticles, which can be in either an orthorhombic or cubic structure. Preferably, the CoSe₂ nanoparticles are in a cubic structure.

This method of electron transfer can occur in an acidic medium, for instance, in a solution composed of 0.5 M H₂SO₄. The Co and Se-containing electrocatalyst component can be a supported Co and Se-containing electrocatalyst component, such as a carbon supported Co and Se-containing electrocatalyst component.

The present method of oxygen reduction involves transferring any number of electrons per oxygen molecule from 3 to 4 electrons per oxygen molecule. In some cases, the method can transfer about 3.5 electrons per oxygen molecule, and in other cases, can involve transferring about 3.7 electrons per oxygen molecule. Under some conditions, the present method can also involve transfer of 4 electrons per oxygen molecule.

The present disclosure also teaches a method of converting the structure of a cobalt and selenium-containing compound by first providing a cobalt and selenium-containing compound, and then heating the cobalt and selenium-containing compound to about 300° C. to form a cobalt and selenium-containing compound with an orthorhombic structure. This orthorhombic cobalt and selenium-containing compound can be isolated in some cases, and then heated to about 400° C. to thereby form a cobalt and selenium-containing compound with a cubic structure.

The heating processes for this present method can include heating for a sufficient time at the indicated temperature to form the desired orthorhombic or cubic structure of the CoSe₂ nanoparticles.

This disclosure further teaches an electrocatalyst for molecular oxygen reduction or hydrogen evolution composed of a carbon-supported CoSe₂ nanoparticle electrocatalyst, wherein the carbon-supported CoSe₂ nanoparticles include CoSe₂ nanoparticles in an orthorhombic or cubic phase structure.

The disclosed electrocatalyst can drive the molecular oxygen reduction or hydrogen evolution reactions via a four-electron transfer at the cathode of the polymer electrolyte fuel cell, in some instances. In other embodiments, the presently disclosed electrocatalyst can transfer any number of electrons per molecule ranging from about 3 to about 4 electrons per molecule.

The present disclosure also teaches a method of evolving hydrogen by providing a hydrogen source, and a Co and Se-containing electrocatalyst component. The hydrogen source can be contacted with the Co and Se-containing electrocatalyst component, and can transfer electrons from the electrocatalyst to the hydrogen source to evolve hydrogen.

The Co and Se-containing electrocatalyst component utilized by this hydrogen evolution method can include CoSe₂ nanoparticles, in particular, CoSe₂ nanoparticles in a cubic structure. The evolution of hydrogen can occur in an acidic medium.

The hydrogen evolution method can utilize Co and Se-containing electrocatalyst components which can include a supported Co and Se-containing electrocatalyst component, such as, a carbon supported Co and Se-containing electrocatalyst component.

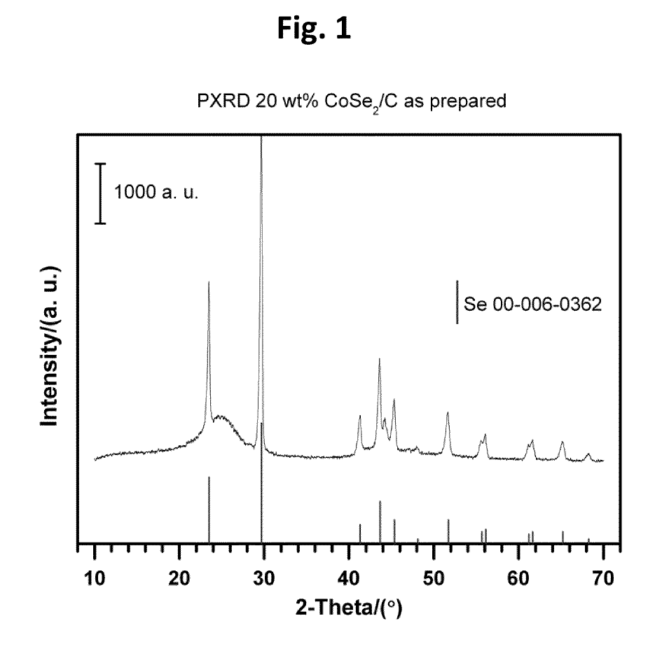

The CoSe₂ nanoparticles of the disclosed electrocatalyst composition have been characterized by powder X-ray diffraction (“PXRD”) studies; the results of which are presented in FIGS. 1, 2 and 3.

Specifically, FIGS. 1, 2 and 3 display PXRD patterns of 20 wt. % CoSe₂/C nanoparticles as prepared, and after 300° C. and 400° C. heat treatments, respectively. Vertical bars represent ICDD-PDF2-2004 cards of selenium (No. 00-006-0362), orthorhombic phase CoSe₂ (No. 00-053-0449) and cubic phase CoSe₂ (No. 03-065-3327). Some hkl Bragg reflection peaks were marked using the corresponding hkl in the figure.

In FIG. 1, the PXRD patterns of the as-prepared sample can be mainly attributed to selenium powder, from a comparison with ICDD PDF card No. 00-006-0362. This pattern indicates that the selenium had not completely reacted with the cobalt particles, and were then absorbed on the final product. The Co particles would be derived from the decomposition of the Co₂(CO)₈ precursor.

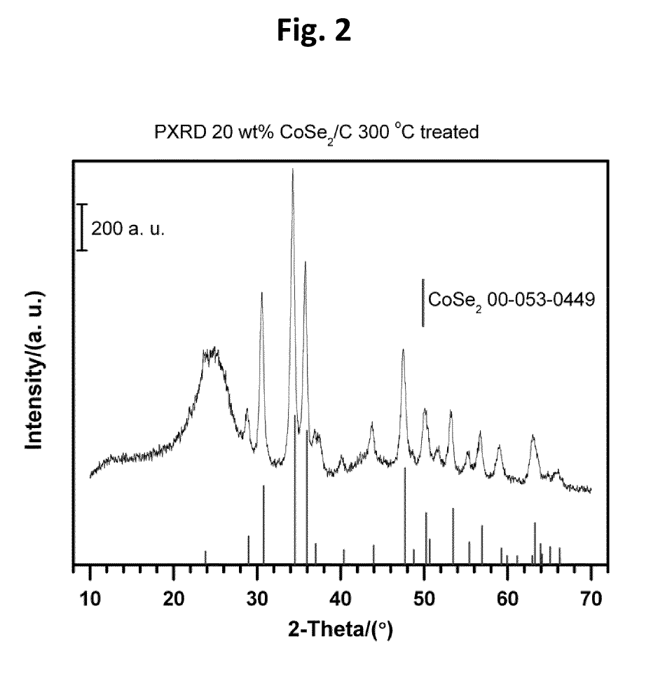

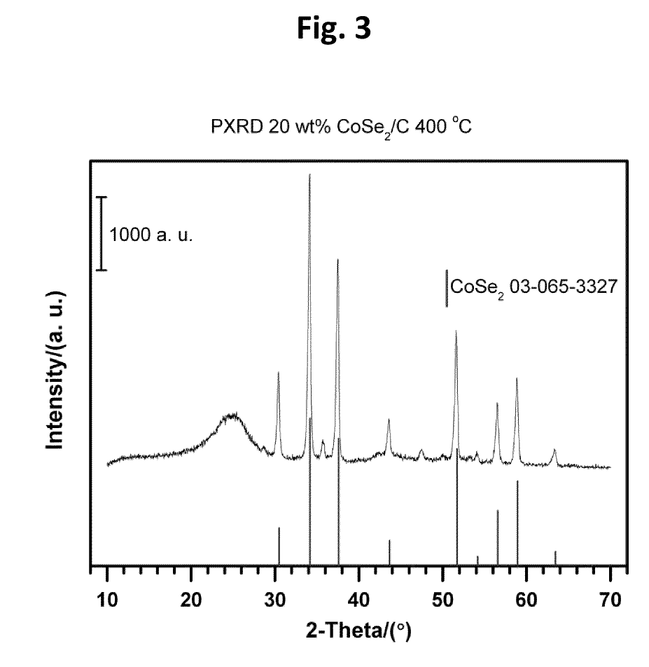

One can observe the characteristic PXRD patterns of the CoSe₂ various phases: the orthorhombic structure (ICDD No. 00-053-0449, see FIG. 2) for 300° C. treated CoSe₂; the cubic structure (Pa3, No. 205, ICDD No. 03-065-3327, see FIG. 3) for 400° C. treated CoSe₂. The 120 and 211 Bragg reflection peaks for the orthorhombic structure at 35.96°/2θ and 47.72°/2θ gradually disappear upon heating, and the 211 and 311 peaks for the cubic structure appear at 37.57°/2θ and 51.70°/2θ after heating at 400° C.

The structural conversion of CoSe₂ from orthorhombic to cubic arrangement is believed to be observed for the first time. Without being limited by theory, this structural conversion is believed to be responsible for the increased ORR activity observed between the orthorhombic and cubic forms of the carbon-supported CoSe₂ catalyst as described herein.

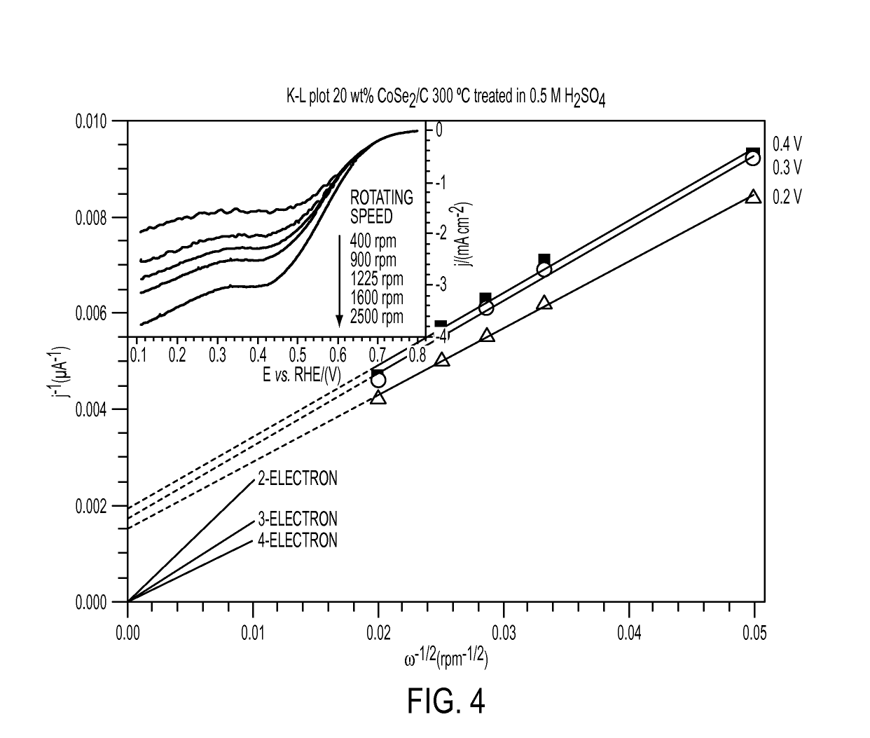

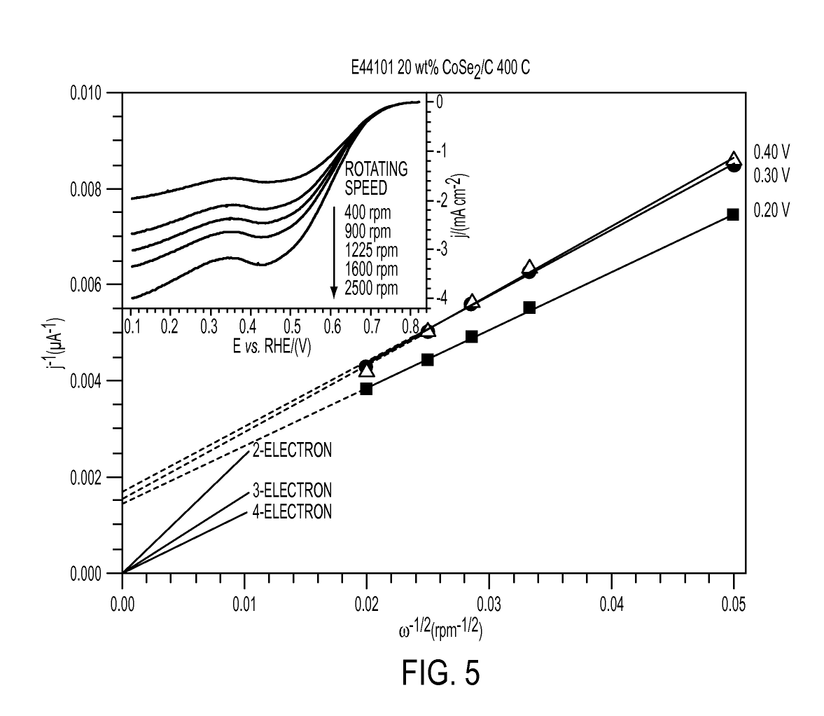

The ORR activity of CoSe₂ nanoparticles supported on carbon at a 20 wt. % loading of CoSe₂ were measured and are presented with the corresponding Koutecky-Levich plots in FIGS. 4 and 5.

FIGS. 4 and 5 show the Koutecky-Levich plots at 0.4 V, 0.3 V and 0.2 V vs. RHE and inset at the top left, the ORR curves, collected on glassy carbon electrode under O₂-saturated 0.5 M H₂SO₄ at 25° C. for 20 wt. % CoSe₂/C nanoparticles after heat treatment at 300° C. (CoSe₂-300 C) and 400° C. (CoSe₂-400 C), respectively.

For the 300° C. heat treated catalyst, the ORR curves (FIG. 4 (inset)) display an OCP value of +0.81 V vs. RHE and a plateau-like cathodic diffusion current in the range from +0.1 V to +0.44 V vs. RHE at a rotating speed from 400 rpm to 2500 rpm.

This observed OCP value is comparable with that of non-precious metal ORR catalysts recently reported by S. A. Campbell and his coauthors: 0.74 V vs. RHE for Co₁₋ₓSe thin film, 0.78 V vs. RHE for CoSe₁₋ₓ/C powder and FeS₂ thin film, 0.80 V vs. RHE for (Fe, Co)S₂ and NiS₂ thin film, and 0.82 V vs. RHE for CoS₂ thin film, respectively. This OCP value is lower than that of (Co, Ni)S₂ thin film (0.89 V vs. RHE).

On the other hand, the cathodic current density of about 2.5 mA cm⁻² at 0.4 V vs. RHE at 1600 rpm is higher than that of the above mentioned CoSe₁₋ₓ/C powder and thin films such as CO₁₋ₓSe, FeS₂, (Fe, Co)S₂, CoS₂, NiS₂ and equal to that of (Co, Ni)S₂ thin film at 0.4 V vs. RHE at 2000 rpm.

The Koutecky-Levich plots were drawn from the ORR curves based on the Koutecky-Levich equation. In FIG. 4, for CoSe₂-300 C, a good linear and parallel relationship at three potentials: 0.2 V, 0.3V and 0.4 V vs. RHE, indicating first-order kinetics for the molecular oxygen electroreduction is seen. An average slope (B⁻¹=0.14±0.01 μA⁻¹ rpm^{1/2}) can be extracted from a function of i⁻¹ vs. ω^{-1/2} at three potentials. According to B=0.2 nFAD^{2/3}ν^{-1/6}C_{O2}, here, about 3.5 electrons were transferred during the reduction per oxygen molecule (where F=96500 C, A=0.07 cm², D=1.40×10⁻⁵ cm²s⁻¹; ν=0.01 cm²s⁻¹ and C_{O2}=1.1×10⁻⁶ mol cm⁻³ under the present experimental conditions). Additionally, the slope for the three potentials is close to the theoretical slope for 4 electrons as seen in FIG. 4.

For CoSe₂-400C, presented in FIG. 5, an average slope (B⁻¹=0.13±0.01 μA⁻¹ rpm^{1/2}) can be extracted from a function of i⁻¹ vs. ω^{-1/2} at three potentials. Here, according to B=0.2 nFAD^{2/3}ν^{-1/6}C_{O2}, about 3.7 electrons were transferred during the reduction per oxygen molecule under the same experimental conditions.

The ORR curves, insert in the FIG. 5, display an OCP value of +0.81 V vs. RHE and a plateau-like cathodic diffusion current in the range from +0.1 V to +0.5 V vs. RHE at a rotating speed from 400 rpm to 2500 rpm.

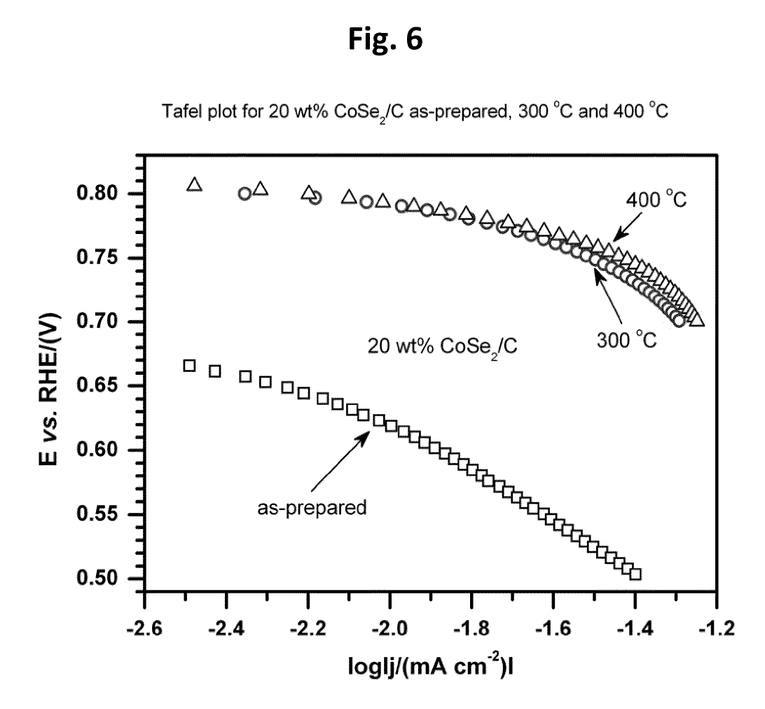

The effect of the heat treatment temperature on the performance of the electrocatalyst for ORR can be seen in FIG. 6. FIG. 6 depicts the electrocatalytic activities of 20 wt. % CoSe₂/C nanoparticles after heat treatment at three different temperatures: as prepared, 300° C., and 400° C., respectively. As described above, CoSe₂ nanoparticles have an orthorhombic structure after heat treatment at 300° C. and then are converted to a cubic structure after heat treatment at 400° C. The CoSe₂/C nanoparticles as-prepared have very low ORR activity which is believed to be due to the influence of unreacted selenium. Heat treatment at temperatures up to 400° C. improves the ORR activity, here, for example, the measured OCP value from 0.67 V vs. RHE for as-prepared to 0.81 V vs. RHE for CoSe₂-400 C. The effect of the heat treatment is also seen in the cathodic current density, measured at 0.50 V vs. RHE at 2500 rpm, which changes from 0.04 mA cm⁻² for as-prepared to 2.5 mA cm⁻² for CoSe₂-300 C and to 3.1 mA cm⁻² for CoSe₂-400 C, respectively.

Correlating with the PXRD results in FIGS. 1, 2 and 3, the ORR catalytic center is believed to be the CoSe₂ phase and cubic CoSe₂ has a higher ORR activity than the orthorhombic form in acid medium. Interestingly, the current density for 20 wt. % CoSe₂/C nanoparticles is about half that of a standard 20 wt. % Pt/C (such as, E-TEK) while the measured OCP value of 0.81 V vs. RHE for 20 wt. % CoSe₂/C nanoparticles is lower than Pt/C (about 0.94 V vs. RHE.)

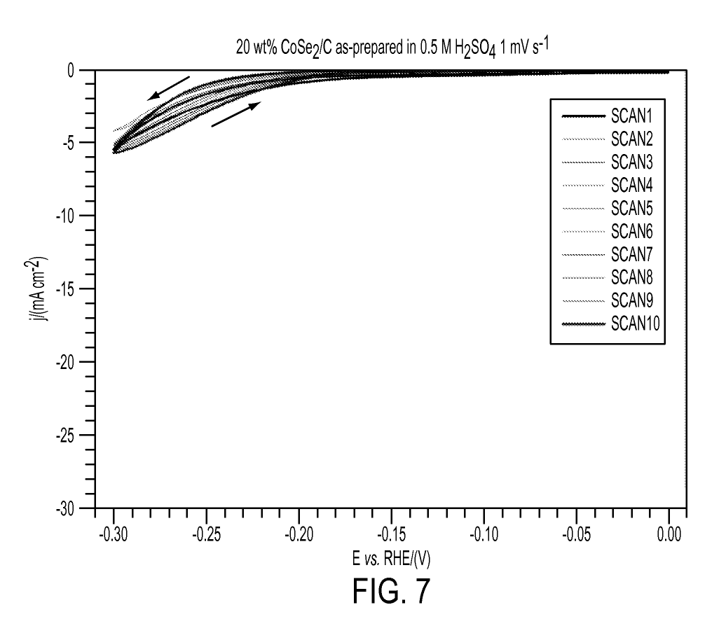

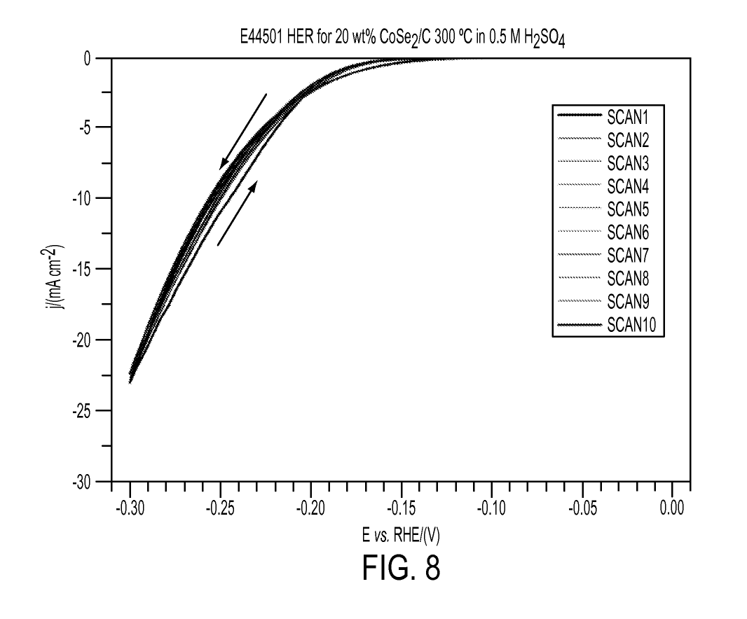

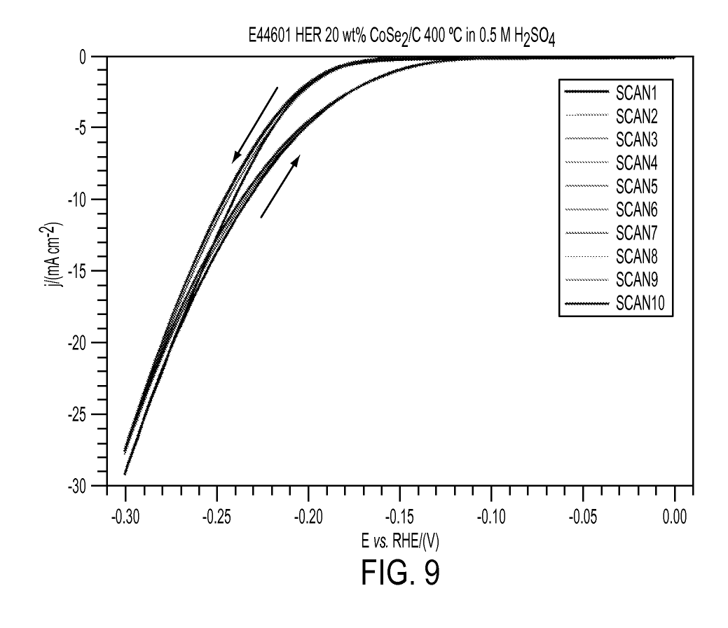

The hydrogen evolution activity of CoSe₂ nanoparticles supported on carbon at a 20 wt. % loading of CoSe₂ were also measured and are presented in FIGS. 7, 8 and 9. More specifically, FIGS. 7, 8 and 9 show the hydrogen evolution performance of 20 wt. % CoSe₂ as-prepared, CoSe₂-300 C and CoSe₂-400 C in 0.5 M H₂SO₄ at 25° C., respectively. Each of these measurements were conducted from 0.0 V vs. RHE to −0.30 V vs. RHE at a scan rate of 1 mV s⁻¹. The as-prepared CoSe₂/C showed very low activity with a maximum current density of about 6 mA cm⁻² and an overpotential of 200 mV. In contrast, after their respective heat treatments, CoSe₂-300 C and CoSe₂-400 C each have an overpotential of 160 mV. It is noted that the maximum current density of CoSe₂-400 C of 28 mA cm⁻² is larger than CoSe₂-300 C which is 23 mA cm⁻². Additionally, it is seen that CoSe₂-400 C appears to be more stable than CoSe₂-300 C in 0.5 M H₂SO₄. The hydrogen evolution activity increases are believed to be due to, and can be attributed to, the structural conversion of CoSe₂ from the orthorhombic form to the cubic form.

Additional details on the preparation and characterization of the CoSe₂ nanoparticles can be found in “Carbon-Supported CoSe₂ Nanoparticles for Oxygen Reduction in Acid Medium,” by Y. J. Feng, T. He and N. Alonso-Vante, Fuel Cells, Vol. 10, Issue 1, pp. 77-83, (December 2009) and “In situ Free-Surfactant Synthesis and ORR-Electrochemistry of Carbon-Supported Co₃S₄ and CoSe₂ Nanoparticles,” by Y. Feng, T. He and N. Alonso-Vante, Chem. Mater., Vol. 20, pp. 26-28 (December 2007) which are hereby incorporated by reference in their entireties for all purposes.

All publications, articles, papers, patents, patent publications, and other references cited herein are hereby incorporated by reference herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

### EXAMPLES

### Experimental

All the chemicals, except for carbon substrate, were used as received from Aldrich-Sigma, Alfa Aesar and Merck companies without any further purification. The carbon substrate was derived from Vulcan XC-72 carbon received from CABOT Co. by activating at 400° C. under a high purity nitrogen atmosphere for 4 hours before being used. Milli-Q Water (18 MΩ·cm) was used during the electrochemical measurements.

### In Situ Surfactant Free Synthesis of CoSe₂ Nanoparticles on Carbon Substrate

Carbon-supported CoSe₂ nanoparticles (20 wt. %) were synthesized by an in situ surfactant free method with heating to reflux temperatures. A typical preparation route according to the present teachings, can begin with 0.135 g Co₂(CO)₈ (0.395 mmol) and 0.68 g carbon (Vulcan XC-72) being dispersed in 10 mL p-xylene under vigorous stirring and nitrogen atmosphere at room temperature for 30 min. Then, the mixture suspension can be heated to reflux. Subsequently, the suspension can be cooled down to room temperature without allowing ageing to occur, and 0.125 g selenium (1.58 mmol), dispersed in 8 mL p-xylene by ultrasonic for 30 min, can be added to the above suspension containing cobalt particles and carbon. The selenium is typically not completely dissolved in the p-xylene solution. The resulting suspension can be mixed at room temperature for 30 min. This suspension can then again be heated to reflux and aged for 30 minutes. A final black powder can be collected on a Millipore filter membrane (diameter 0.22 μm, pore size), washed with anhydrous ethanol and dried in vacuum at room temperature. Further annealing treatments can be conducted at 300° C. (hereinafter indicated as “CoSe₂-300 C”) and 400° C. (hereinafter indicated as “CoSe₂-400 C”) under a high purity nitrogen atmosphere for three hours before electrochemical measurement, respectively.

### Characterization Techniques

Powder X-ray diffraction measurements were performed on a Bruker D5005 diffractometer under the following conditions: 40 kV, 40 mA CuK_{α} (λ=1.5418 Å) radiation. The samples, as non-oriented powders, were step-scanned in steps of 0.03° (2θ) in the range of 20-70° using a counter time of 5 s per step. In situ high temperature powder X-ray diffraction was carried out on a Bruker D8 diffractometer with an Anton Paar HTK 1200 oven in the range of 25-900° C. with a rate of 5° C. min⁻¹ under air. Scans were made in steps of 0.03° (20) every 5 s after a given temperature was reached and held constant for 30 minutes.

The rotating disk electrode (“RDE”) measurements were performed in a three-electrode electrochemical cell using a potentiostat (μ-Autolab Type II) at 25° C. The working electrode was a glassy carbon disk with a 3.0 mm diameter (0.07 cm²). The catalyst ink was prepared by dispersion of 4 mg powder in a mixture solution of 250 μL Nafion® solution (5 wt. % in a mixture of lower aliphatic alcohols and water from Aldrich) and 1250 μL ultrapure water (18 MΩ·cm) in an ultrasonic bath for two hours. The 3 μL catalyst ink was deposited on the glassy carbon disk after having been polished with Al₂O₃ powder (5A). Aqueous 0.5 M H₂SO₄ was used as an electrolyte. Glassy carbon and hydrogen electrodes prepared in the laboratory were used as the counter and reference electrodes. Before the electrochemical measurements, the electrolyte was deaerated by bubbling high purity nitrogen through it for 30 min. A linear-sweep voltammogram was recorded by scanning the disk potential vs. RHE at 5 mV s⁻¹ at various rotating speeds, such as, for example, 400, 900, 1225, 1600 and 2500 rpm, after 10 cycles of cyclic voltammetry under nitrogen atmosphere to clean the electrode surface.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A method of preparing carbon-supported CoSe₂ nanoparticles comprising:
providing a support material;
providing a Co precursor;
providing a Se precursor;
contacting the support material and the Co precursor in a non-aqueous surfactant free reaction mixture;
heating the reaction mixture to a maximum temperature of no greater than about 200° C.;
contacting the Se precursor with the reaction mixture;
heating the reaction mixture to a maximum temperature of no greater than about 200° C., and
isolating a supported CoSe₂-containing component.

2. The method according to claim 1, further comprising heating the supported CoSe₂-containing component to about 300° C. to produce a supported orthorhombic phase CoSe₂-containing component.

3. The method according to claim 1, further comprising heating the supported CoSe₂-containing component to about 400° C. to produce a supported cubic phase CoSe₂-containing component.

4. The method according to claim 1, wherein the support material comprises carbon.

5. The method according to claim 1, wherein each heating step comprises heating for less than about 1 hour.

6. The method according to claim 1, wherein each heating step comprises heating for less than about 30 minutes.

7. The method according to claim 1, wherein each heating step comprises heating to a maximum temperature of no greater than about 150° C.

8. A method of reducing oxygen comprising
providing oxygen,
providing a Co and Se-containing electrocatalyst component,
contacting oxygen with the Co and Se-containing electrocatalyst component, and
transferring from 3 to 4 electrons per oxygen molecule from the electrocatalyst to the oxygen to thereby reduce the oxygen.

9. The method according to claim 8, wherein the Co and Se-containing electrocatalyst component comprises CoSe₂ nanoparticles.

10. The method according to claim 9, wherein the CoSe₂ nanoparticles in either an orthorhombic or cubic structure.

11. The method according to claim 9, wherein the CoSe₂ nanoparticles are in a cubic structure.

12. The method according to claim 8, wherein the transfer of electrons occurs in an acidic medium.

13. The method according to claim 12, wherein the acidic medium comprises 0.5 M H₂SO₄.

14. The method according to claim 8, wherein the Co and Se-containing electrocatalyst component comprises a supported Co and Se-containing electrocatalyst component.

15. The method according to claim 14, wherein the supported Co and Se-containing electrocatalyst component comprises a carbon supported Co and Se-containing electrocatalyst component.

16. The method according to claim 8, wherein the transferring of electrons comprises transferring about 3.5 electrons per oxygen molecule.

17. The method according to claim 8, wherein the transferring of electrons comprises transferring about 3.7 electrons per oxygen molecule.

18. An electrocatalyst for molecular oxygen reduction or hydrogen evolution comprising
a carbon-supported CoSe₂ nanoparticle electrocatalyst,
wherein the carbon-supported CoSe₂ nanoparticles comprise CoSe₂ nanoparticles in an orthorhombic or cubic phase structure.

19. The electrocatalyst according to claim 18, wherein the molecular oxygen reduction comprises
a four-electron transfer at the cathode of the polymer electrolyte fuel cell.

20. A method of evolving hydrogen comprising
providing a hydrogen source,
providing a Co and Se-containing electrocatalyst component,
contacting the hydrogen source with the Co and Se-containing electrocatalyst component, and
transferring electrons from the electrocatalyst to the hydrogen source to evolve hydrogen.

21. The method according to claim 20, wherein the Co and Se-containing electrocatalyst component comprises CoSe₂ nanoparticles.

22. The method according to claim 21, wherein the CoSe₂ nanoparticles are in a cubic structure.

23. The method according to claim 20, wherein the evolution of hydrogen occurs in an acidic medium.

24. The method according to claim 20, wherein the Co and Se-containing electrocatalyst component comprises a supported Co and Se-containing electrocatalyst component.

25. The method according to claim 24, wherein the supported Co and Se-containing electrocatalyst component comprises a carbon supported Co and Se-containing electrocatalyst component.
